(19) United States
(12) Patent Application Publication
(10) Pub. No.: US 2011/0254361 A1
(43) Pub. Date: Oct. 20, 2011

(54) BRAKE SYSTEM FOR MOTOR VEHICLES

(76) Inventors: Silke Scharmann, Wuerzburg (DE); Roland Galbas, Ludwigsburg (DE); Jeannine Daubenschmid, Leonberg (DE); Matthias Schanzenbach, Eberstadt (DE)

(21) Appl. No.: 13/057,607

(22) PCT Filed: Jul. 6, 2009
(86) PCT No.: PCT/EP2009/058494

§ 371 Date: May 2, 2011

(30) Foreign Application Priority Data
Aug. 25, 2008 (DE) 10 2008 041 498.0

(51) Int. Cl. B60T 13/20; B60T 8/17; B60T 7/12

(52) U.S. Cl. 303/10

(57) ABSTRACT

A brake system for motor vehicles, having a pump for conveying brake fluid into a brake pressure line; a motor able to be connected to an on-board voltage source, for driving the pump; and a control device for the motor, wherein an electric energy-storage device is provided in addition to the on-board voltage source, and the control device is designed to connect the motor to the energy-storage device intermittently. The energy-storage device may be a booster battery or a capacitor.

### FIELD OF THE INVENTION

The present invention relates to a brake system for motor vehicles, having a pump for conveying brake fluid into a brake pressure line; a motor for driving the pump, which is able to be connected to an on-board voltage source; and a control device for the motor.

### BACKGROUND INFORMATION

The brake pressure line of such a brake system is used to provide the necessary brake pressure to the individual wheel cylinders. At the wheel cylinders, the brake pressure is usually modulated as a function of the rotational and slip conditions of the wheels, with the aid of modulation valves, which obtain signals from an ABS or ESP control device (anti-lock system and electronic stability program). In this context, in specific intervals brake pressure from the brake pressure line is introduced into the wheel cylinders, the brake pressure is maintained, or brake fluid is released into a storage tank in order to reduce the brake pressure. The pump has the purpose of conveying the brake fluid from the storage tank back into the brake pressure line, so that the brake pressure in the wheel cylinders is able to be built up at any time, as needed. The motor that drives this pump is also controlled by the control device and obtains its drive energy from the on-board voltage source of the vehicle.

Today, motor vehicles are increasingly being equipped with active safety systems that monitor the traffic surroundings with the aid of a suitable sensor system, using radar sensors, for example, and that actively intervene in the vehicle guidance when necessary, in order to prevent an impending collision if possible or at least to reduce the consequences of the collision. An example of such a safety system is a so-called PEB system (predictive emergency braking), with which an active emergency braking may be initiated if an immediate risk of collision is detected by the sensor system.

However, an active brake intervention using high-power braking deceleration (active emergency braking) can be implemented only if other options for preventing an accident, such as swerving, are no longer possible. It is also necessary for the evaluation of the traffic situation with the aid of the signals of the sensor system to have a high plausibility, so that it may be assumed with a sufficiently high probability that the traffic situation was evaluated correctly and an acute risk of collision actually exists. Under these conditions, usually only a very short time period remains for initiating and implementing the emergency braking. It therefore may be important that it be possible to build up the pressure in the wheel brake cylinders very quickly in the case of such an emergency braking. In other words, a high pressure build-up dynamic may be required so that the brakes are able to deploy their maximum effectiveness with the minimum possible delay.

Hydraulic methods, in particular a so-called brake pre-filling, are currently used to improve the pressure build-up dynamic or to reduce the so-called brake response times in emergency braking situations. In this context, the brake pressure is increased preventatively already at a time at which the initiation of an emergency braking is probable but the final decision is not yet made; it is increased only up to the threshold at which a braking deceleration actually sets in, however. If an emergency braking then really must be triggered, the maximum brake pressure may be reached more quickly.

The pressure build-up takes place with the aid of the pump of the ESP aggregate and/or with the aid of active boosters.

However, only a limited pressure build-up dynamic may be achieved using these measures. Better results may be achieved by using systems in which additional brake pressure can be provided with the aid of hydraulic pressure reservoirs. However, such systems are very expensive and technically are very complex.

### SUMMARY

An object of the present invention is to create a brake system in which a higher pressure build-up dynamic may be achieved using a simple arrangement.

According to an example embodiment of the present invention, this object may be achieved in that in addition to the on-board voltage source, an electric energy-storage device is provided, and the control device is designed to connect the motor to the energy-storage device intermittently.

In the example brake system according to the present invention, a higher pressure build-up dynamic is thus achieved in that the motor driving the pump is connected to an energy-storage device when necessary, so that a higher operating voltage is available for the motor, and the pump conveying capacity is thus increased.

In particular, this exploits the condition that when there is an electric drive motor for a pump, the nominal voltage, which normally corresponds with the voltage of the on-board battery of the vehicle, may be clearly exceeded briefly, which results in a corresponding increase in the drive power, without the increased voltage causing destruction of damage of the motor. Since the high pressure build-up dynamics are required only in acute emergency situations, it may be justified to increase the voltage to levels that would cause a clear reduction in the service life of the motor if used in continuous operation.

The present invention requires only relatively slight modifications to a traditional brake system, namely generally only the provision of an energy-storage device and a corresponding modification of the control device. Costly aggregates such as active boosters or hydraulic reservoirs and the like are not required. This results in not only cost reductions, but also a higher functional safety due to the low complexity of the brake system.

The energy-storage device may be one or a plurality of capacitors or booster batteries or combinations of the two. In the case of a plurality of capacitors and/or booster batteries, these may be connected in parallel or in series, or they may also form a network of parallel and series connections. The energy-storage device may also be connected optionally in series or in parallel to the on-board voltage source.

### BRIEF DESCRIPTION OF THE DRAWINGS

Exemplary embodiments of the present invention are shown in the figures and explained in greater detail below.

FIG. 1 shows a block diagram of an example brake system according to the present invention.

FIGS. 2 and 3 show alternative electric circuits for the example brake system showing FIG. 1.

FIG. 4 shows a circuit sketch for a brake system according to an additional exemplary embodiment.

FIGS. 5 and 6 show circuit sketches of a brake system according to an additional exemplary embodiment in different operating states.

FIGS. 7 and 8 show circuit sketches for an additional exemplary embodiment of the brake system in different operating states.

### DETAILED DESCRIPTION OF EXAMPLE EMBODIMENTS

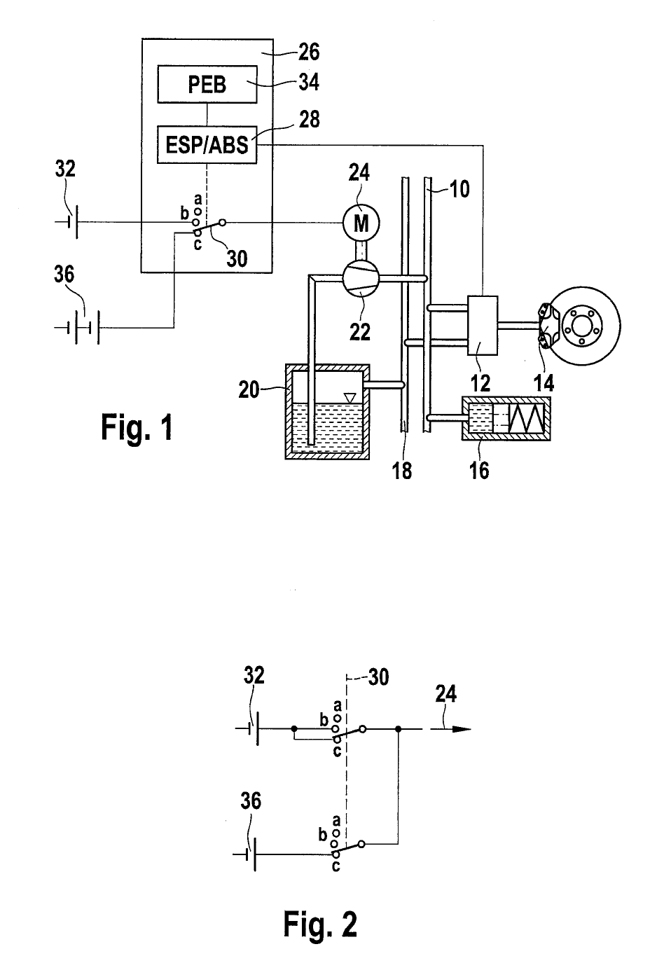

The brake system illustrated in FIG. 1 has a brake pressure line 10 that is connected via respective modulation valves 12 to individual wheel-brake cylinders 14 of the vehicle (only one single wheel-brake cylinder is shown in the figure).

In the illustrated example, a compensating tank 16 for compensating for pressure fluctuations is also connected to brake pressure line 10.

Brake pressure line 10 may be connected via modulation valve 12 to wheel brake cylinder 14, so that brake pressure is built up in the brake cylinder. Likewise, the connection may be separated, so that the brake pressure is maintained in the brake cylinder, or wheel brake cylinder 14 may be connected to a return line 18, so that brake fluid is released via the return line into a storage tank 20, thus reducing the brake pressure in the wheel cylinder.

A pump 22 is driven by an electric motor 24 and is used to convey the brake fluid from storage tank 20 back into brake pressure line 10, so that the necessary pressure is constantly maintained in this brake pressure line. In practice, pump 22 is operated only at intervals in order to replace the fluid introduced into the wheel brake cylinders during a brake operation or to replace the brake fluid released via return line 18 after a brake operation.

In the illustrated example, an electronic control device 26 includes an electronic driving-stabilization and anti-lock braking system (ESP/ABS) 28, which controls modulation valves 12 with the aid of the signals from wheel-speed sensors and other sensors. Control device 26A also has a switch 30 that is controlled by ESP/ABS system 28 and is used to connect motor 24 to an on-board voltage source 32 (the vehicle battery), in order to put pump 22 into operation (switch position “b” in FIG. 1) or to separate the motor from the on-board voltage source and thus to turn off the pump (switch position “a”).

In the normal case, the brake system is activated by the driver of the vehicle via the brake pedal. For this purpose, brake pressure line 10 is connected in a conventional manner to a brake cylinder or brake booster not shown in this instance.

In the example illustrated here, control device 26 is supplemented by a so-called PEB system 34 (predictive emergency braking), which is able to automatically trigger an emergency braking in specific traffic situations that are detected by a sensor system, which is not illustrated. To this end, the PEB system issues a command to ESP/ABS system 28, which then activates pump 22 and opens modulation valve 12, in order to apply pressure to wheel brake cylinders 14. Since the brake force should become effective as rapidly as possible in an emergency situation, wheel brake cylinders 14 are filled with brake fluid very quickly, thus making it possible for the brake pressure to be built up very rapidly. The normal output of motor 24 and pump 22 often will not suffice for this purpose. Therefore, the example brake system described herein additionally has an electric energy-storage device, which is formed by a booster battery 36 in FIG. 1.

Switch 30, which was described above, has a third switch position “c,” in which it connects motor 24 to booster battery 36. If PEB system 34 issues the command for an emergency braking, ESP/ABS system 28 thus puts switch 30 into switch position “c,” so that motor 24 is powered by booster battery 36. In the example illustrated here, the motor is then separated from the regular vehicle battery, that is, on-board voltage source 32. Booster battery 36 has a higher voltage, however, so a higher voltage is applied to motor 24, for example, 18 V instead of the usual 12 V, and motor 24 accordingly drives pump 22 with a higher power output. In this way, it is possible to build up the pressure in wheel brake cylinder 14 with significantly higher dynamics.

Since the emergency brake operation in general lasts only a few seconds, it is possible to switch back into switch position “b” or “a” very soon, so that despite the increased voltage, no damage occurs to motor 24.

Since in the exemplary embodiment shown in FIG. 1, motor 24 is powered either only by on-board voltage source 32 or only by booster battery 36, the voltage of booster battery 36 can be selected to be higher than that of the on-board voltage source. Apart from this, in this system the voltage supply of motor 24 during the emergency braking operation is independent from possible fluctuations in the vehicle system voltage.

FIG. 2 illustrates a circuit for a modified specific embodiment, in which if switch 30 is in switch position “c,” illustrated in this instance, during the emergency braking operation, on-board voltage source 32 and booster battery 36 are switched in parallel. In this case, the output voltage of booster battery 36 indeed should not be higher than that of the on-board voltage source; however, through the parallel connection the inner resistance of the voltage supply as a whole is reduced, so that when there is a flow of current through motor 24, in particular at a low state of charge of the vehicle battery, a higher voltage drop results at the motor.

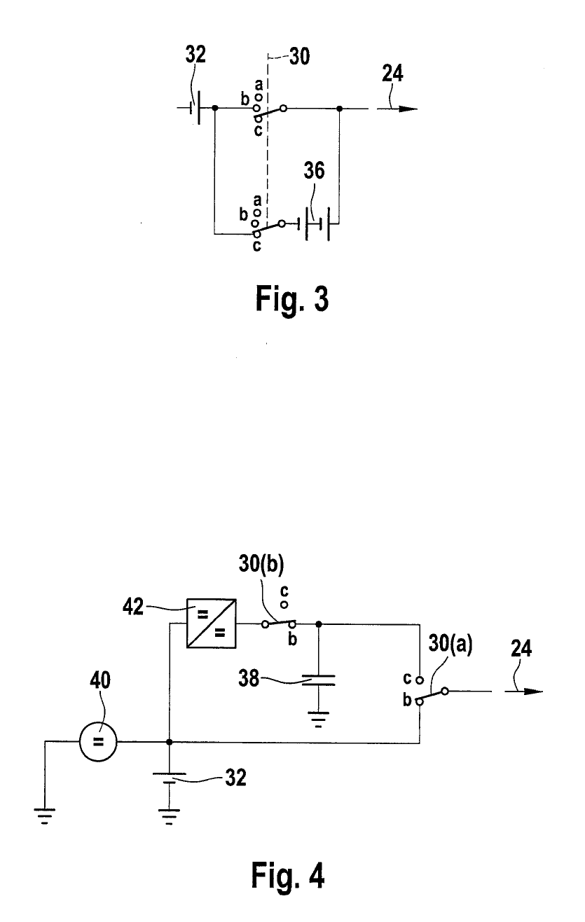

FIG. 3 illustrates an example in which during the emergency braking operation, in position “c” of switch 30, on-board voltage source 32 and booster battery 36 are connected in series. In this case, the output voltage of booster battery 36 may be lower or higher than that of the on-board voltage source.

In FIGS. 2 and 3, in switch position “b,” motor 24 is connected only to on-board voltage source 32, and in switch position “a,” motor 24 is disconnected entirely.

FIGS. 4 to 8 illustrate specific embodiments in which the energy-storage device is formed not by a booster battery, but rather by a capacitor 38, preferably a double-layer capacitor (DLC).

In the example illustrated in FIG. 4, motor 24 is connected via switch 30 either to on-board voltage source 32 (switch position “b”) or to capacitor 38 (switch position “c”). For the sake of simplicity, switch-off position “a” is not shown here. In this case, switch 30 has two switch elements 30(a) and 30(b) that are coupled to each other.

On-board voltage source 32 is normally made up of the vehicle battery, which is charged with the aid of a generator 40 of the vehicle. In switch position “b,” capacitor 38 is connected to on-board voltage source 32 via switch element 30(b) and a DC/DC converter 42, which converts the output voltage of the vehicle battery into a higher charging-voltage of capacitor 38. In the event of an emergency braking operation, if switch 30 is switched to position “c,” then capacitor 38 discharges, so that a higher operating voltage is available for motor 24. The capacitance of capacitor 38 should be so great that the voltage of this capacitor, while it discharges via motor 24, does not decrease too much over the course of the emergency braking operation, or at any rate it only decreases more markedly when the full brake pressure has built up.

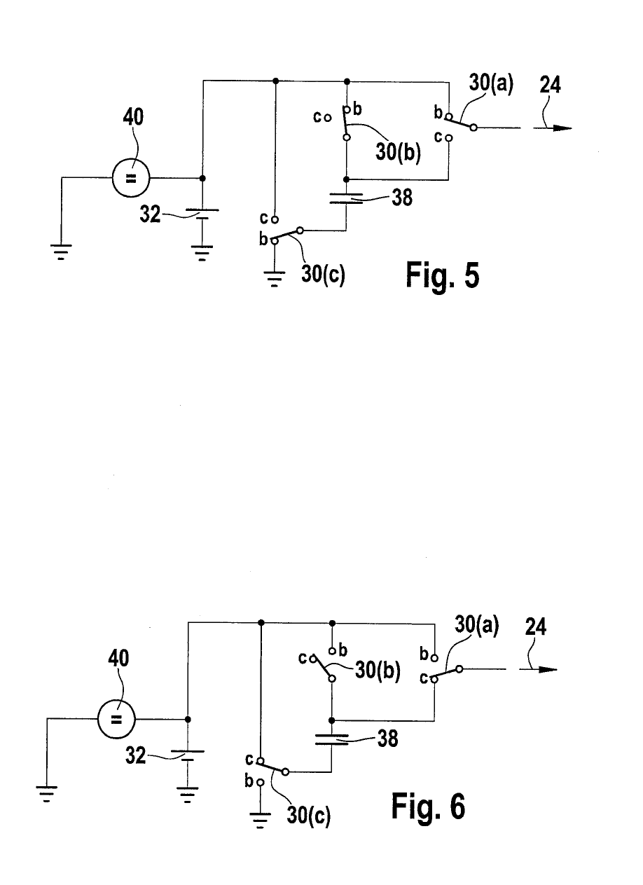

FIGS. 5 and 6 illustrate a specific embodiment in which capacitor 38 is connected in series to on-board voltage source 32 during the emergency braking operation, and in which no

DC/DC converter is required. In this case, switch 30 has three switch elements 30(a), 30(b), and 30(c) that are coupled to each other.

In FIG. 5, the switch is in switch position “b,” in which motor 24 is connected via switch element 30(a) only to on-board voltage source 32. In this switch position, capacitor 38 is connected to on-board voltage source 32 in parallel to motor 24 via switch element 30b, and its other electrode is grounded via switch element 30(c), so that the capacitor is charged to the voltage of on-board voltage source 32 and then maintained at this voltage.

When a change is made into switch position “c” shown in FIG. 6, then switch element 30(b) is opened, and switch element 30(c) no longer connects capacitor 38 to ground, but rather to on-board voltage source 32, so that the total potential of capacitor 38 is raised by the voltage of on-board voltage source 32. Now twice the output voltage of on-board voltage source 32 is applied to motor 24 via switch element 30(a). The current flowing through motor 24 is the discharging current of capacitor 38. Thus, in this instance as well, the capacitor should have a relatively high capacitance.

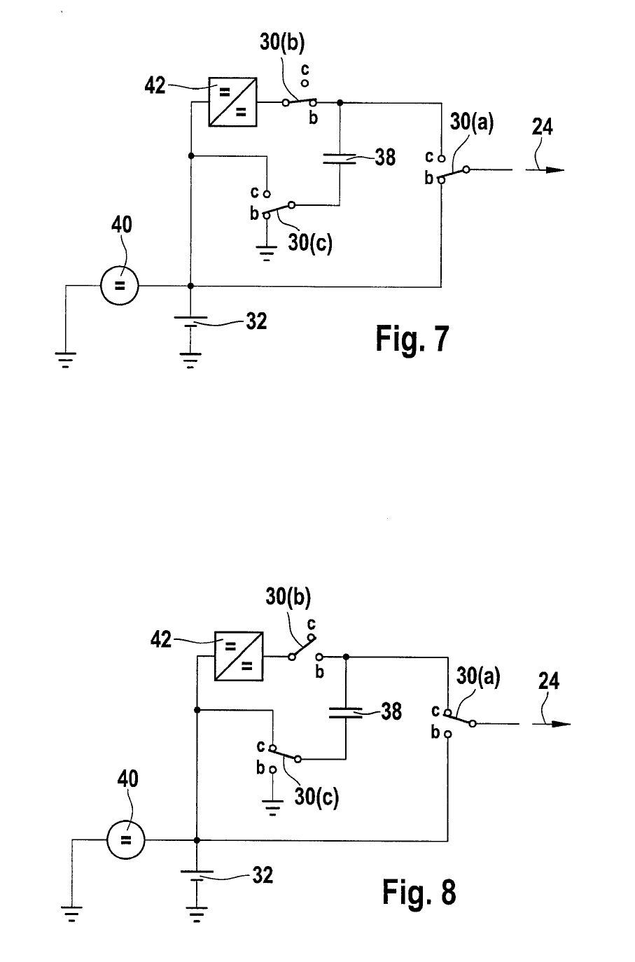

FIGS. 7 and 8 illustrate an example in which on-board voltage source 32 and capacitor 38 are likewise connected in series during the emergency braking operation, in which, however, the charging voltage of capacitor 38 may be additionally increased with the aid of DC/DC converter 42. In circuit position “b” illustrated in FIG. 7, motor 24 is connected via switch element 30(a) only to on-board voltage source 32, while capacitor 38 is connected to earth via switch element 30(c) and is charged via DC/DC converter 42 and switch element 30(b).

In switch position “c” according to FIG. 8, capacitor 38 discharges via switch element 30(a) while its potential is raised by switch element 30(c) to the output voltage of on-board voltage source 32.

1-8. (canceled)

9. A brake system for a motor vehicle, comprising:
a pump to convey brake fluid into a brake pressure line;
a motor able to be connected to an on-board voltage source to drive the pump;
a control device for the motor; and
an electric energy-storage device, provided in addition to the on-board voltage source, wherein the control device is adapted to connect the motor to the energy-storage device intermittently.

10. The brake system as recited in claim 9, wherein the energy-storage device has a booster battery.

11. The brake system as recited in claim 9, wherein the energy-storage device has at least one energy-storing capacitor.

12. The brake system as recited in claim 11, wherein the capacitor is connected to the on-board voltage source via a converter and may be charged by the converter to a voltage that is higher than that of a voltage of the on-board voltage source.

13. The brake system as recited in claim 9, wherein the control device is adapted to connect the motor alternately to the on-board voltage source and the energy-storage device.

14. The brake system as recited in one of claim 9, wherein the control device is configured to connect the on-board voltage source and the energy-storage device in parallel to the motor.

15. The brake system as recited in claim 9, wherein the control device is adapted to connect the on-board voltage source and the energy-storage device in series to the motor.

16. The brake system as recited in claim 9, further comprising:
an active safety system that is adapted to issue a command for an automatic triggering of an emergency braking as a function of the traffic situation, and the control device is adapted to connect the motor to the energy-storage device during the emergency braking.
